(19) United States
(12) Patent Application Publication
(10) Pub. No.: US 2006/0115169 A1
(43) Pub. Date: Jun. 1, 2006

(54) Apparatus for compressing document and method thereof

(76) Inventor: Hyung-soo Ohk, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/288,397

(22) Filed: Nov. 29, 2005

(30) Foreign Application Priority Data
Dec. 1, 2004 (KR) 2004-99896

(51) Int. Cl. G06K 9/36; G06K 9/34

(52) U.S. Cl. 382/239; 382/176

(57) ABSTRACT

Disclosed are a document compression apparatus and a method thereof. The document compression apparatus comprises an input section for receiving an image data created by scanning a document. A region classifier analyzes the image data and classifies it into a text region and an image region. A text compressor substitutes a predetermined representative value for the pixel value of a pixel belonging to the text region and compresses the image data of the text region. An image compressor compresses the image data of the image region. Accordingly, the pixel values of the pixels belonging to the text region are substituted with a predetermined representative value and compressed while maintaining the original constant color of the text, thereby preventing degradation of the image quality.

### CROSS REFERENCE TO RELATED APPLICATIONS

This application claims the benefit under 35 U.S.C. § 119(a) of Korean Patent Application No. 2004-99896 filed Dec. 1, 2004, in the Korean Intellectual Property Office, the entire disclosure of which is incorporated herein by reference.

### BACKGROUND OF THE INVENTION

1. Field of the Invention

The present invention relates to a document compression apparatus and a method thereof. More specifically, the invention relates to a document compression apparatus and method thereof, which compresses a text region and an image region in the image data of a mixed document, while maintaining the original color.

2. Description of the Related Art

A document having at least one text region and at least one image region is called a mixed document. Here, the text is a region, for example, comprises an edge having a distinct and strong contrast in a document.

The MRC (Mixed Raster Content) method has been proposed as a method of compressing a mixed document. The MRC method decomposes the scanned image data of a document into an upper layer (or a foreground layer), a mask layer (or a selector plane), and a lower layer (or a background layer), compresses each layer individually using a compression method appropriate to each layer, restores each compressed layer, and recomposes the original document.

Scan data generated by scanning a mixed document is represented as a pixel map, and the pixel map is formed of data for each pixel forming a document, preferably brightness data (hereafter, refer to as a pixel value). Generally, a pixel map has pixel values represented by 256 steps of integer value for each pixel. For example, in the case of a black and white pixel map, the pixel map has pixel values from ‘0’ representing the black color to ‘255’ representing the white color.

According to the MRC method, a pixel map generated by scanning a mixed document that contains images and text is decomposed into three layers considering pixel values, together with the neighboring pixel values. That is, a mask layer is created by separating the data corresponding to text from the pixel map, the mask layer of a 1-bit bit map formed of 1's for the pixel values of a text and 0's for the pixel values of the other region. An upper layer is created by separating the color data of the pixels having the pixel value ‘1’ in the mask layer, that is, the color data of the text. A lower layer is created by separating the color data of the pixels having the pixel value ‘0’ in the mask layer, that is the color data of the other region including images and a background screen.

In case of the upper layer according to the MRC decomposition, in order to down-sample the high resolution color data in a low resolution and compress the down-sampled color data, the data is processed in various methods such as the Nearest Neighbor Method.

However, according to the above described method, in the case where the pixel values of the neighboring pixels are extremely different from each other, the color of a pixel changes from the color of the original document due to the down-sampling, and the image quality is degraded.

Specifically, text is generally represented by one color in an original document. However, in the case of a region where pixel values are extremely different from those of neighboring pixels such as an edge, a representative value having a different color from the original color is selected due to the influence of the neighboring pixels, so that the color changes diversely even in one text.

FIGS. 1A to 1E show a compressed image according to a conventional compression method.

FIG. 1A is a pixel image map having a color changed from its original color while a text represented in one color passes through image processing procedures such as half-toning, outputting, or scanning. FIG. 1B shows a mask layer, which is a 1-bit bit map image data separated from the pixel map of FIG. 1A.

FIG. 1C shows an image after image processing is performed nine times on the image of FIG. 1A. The color of the characters have been changed greatly from the color of the original image.

FIG. 1D shows an image resulting from compressing the down-sampled image data in FIG. 1C using the JPEG method. FIG. 1E is the final image that is created by restoring the compressed image data and synthesizing the data of each layer. Referring to FIG. 1D, while the original image data passes through down-sampling and JPEG compression processes, the image quality is degraded by the change of color. In addition, referring to FIG. 1E, the text represented in one color in the original image is represented in variously changing colors.

That is, according to the conventional technology, the text color is changed and the image quality is degraded by the data processing and down-sampling process in the compression process of the text, thereby decreasing the quality of compression.

Accordingly, there is a need for an improved document compression apparatus and method that compresses text regions and image regions without changing the color of text and thereby degrading the document quality.

### SUMMARY OF THE INVENTION

Embodiments of the present invention are made in order to solve the above drawbacks and other problems in the art, as well as to provide other advantages that will be apparent to those of ordinary skill in the art from the following detailed description. One aspect of the invention is to provide a document compression apparatus and a method thereof, which compresses the text region amongst the text and image regions in a screen while maintaining the original color of the text when compressing a mixed document of texts and images, thereby improving any degradation of the image quality.

According to one aspect of the invention, there is provided a document compression apparatus comprising an input section for receiving image data created by scanning a document. A region classifier analyzes the image data and classifies it into a text region and an image region. A text compressor substitutes a predetermined representative value for the pixel value of a pixel belonging to the text region and compresses the image data of the text region. An image compressor compresses the image data of the image region.

Preferably, the text compressor includes a text divider for detecting interconnectivity according to the location of the pixels belonging to the text region and dividing the pixels into pixel groups having consecutively connected pixels. A representative value calculator calculates a representative pixel value for each pixel group. A substitution section substitutes the representative pixel value for the pixel value of each pixel included in the pixel group respectively.

In addition, the text divider preferably divides the pixels belonging to each pixel group into the pixels within the pixel group and the pixels outside of (at the edge of) the pixel group respectively. The representative value calculator preferably calculates the representative pixel value by assigning different weighting factors to the pixels within the pixel group and the pixels out of the pixel group respectively.

Also, the representative value calculator preferably assigns a weighting factor to the pixel value of the pixel within the pixel group, the weighting factor being higher than that of the pixel value of the pixel outside of the pixel group, and calculates the mean value of the pixel values as the representative value, the pixel values being assigned with the weighting factor.

In addition, the substitution section compares the pixel values of the pixels belonging to the pixel group, and, in the case where the difference exceeds a predetermined threshold value, the representative value preferably does not substitute for the pixel value.

Preferably, the region classifier separates the black and white bit map data representing the text region from the image data, and classifies the image data into the color data representing the text region and the image data representing the image region using the black and white bit map data.

In addition, the text compressor preferably calculates the representative value of the pixels belonging to the text region using the color data.

Then, the text compressor preferably applies a different compression method to the bit map data, the color data, and the image region respectively according to the characteristic of the data in which the image data is classified into the bit map data, the color data, and the image region.

On the other hand, the compression method according to an embodiment of the present invention comprises receiving the image data created by scanning a document The image data is analyzed and classified into a text region and an image region A representative pixel value is calculated for at least one pixel group after dividing the text region into at least one pixel group having consecutively connected pixels respectively The representative pixel value is substituted for the pixel value of each pixel included in at least one pixel group. The image data of the text region and the image data of the image region are compressed.

Preferably, the representative pixel value calculating step divides the pixels belonging to the pixel groups into the pixels within the pixel group and the pixels outside of (at the edge of) the pixel group respectively, and calculates a representative pixel value by assigning different weighting factors.

Also, the representative pixel value calculating step preferably assigns a weighting factor to the pixel value of the pixel within the pixel group, the weighting factor being higher than that of the pixel value of the pixel outside of the pixel group, and calculates the mean value of the pixel values as the representative value, the pixel values being assigned with the weighting factor.

In addition, the substituting step preferably compares the pixel values of the pixel belonging to the pixel group, and, in the case where the difference exceeds a predetermined threshold value, the representative value preferably does not substitute for the pixel value.

Here, the region classifying step preferably separates the black and white bit map data representing the text region from the image data, and classifies the image data into the color data representing the text region and the image data representing the image region using the black and white bit map data.

Here, the representative pixel value calculating step preferably calculates the representative pixel value of the pixels belonging to the text region using the color data.

In addition, the compressing step preferably applies a different compression method to the bit map data, the color data, and the image region respectively according to the characteristic of the data, in which the image data is classified into the bit map data, the color data, and the image region.

### BRIEF DESCRIPTION OF THE DRAWINGS

The above aspects and features of the present invention will be more apparent by describing certain exemplary embodiments of the present invention with reference to the accompanying drawings, in which:

FIGS. 1A to 1E show compressed images according to a conventional compression method;

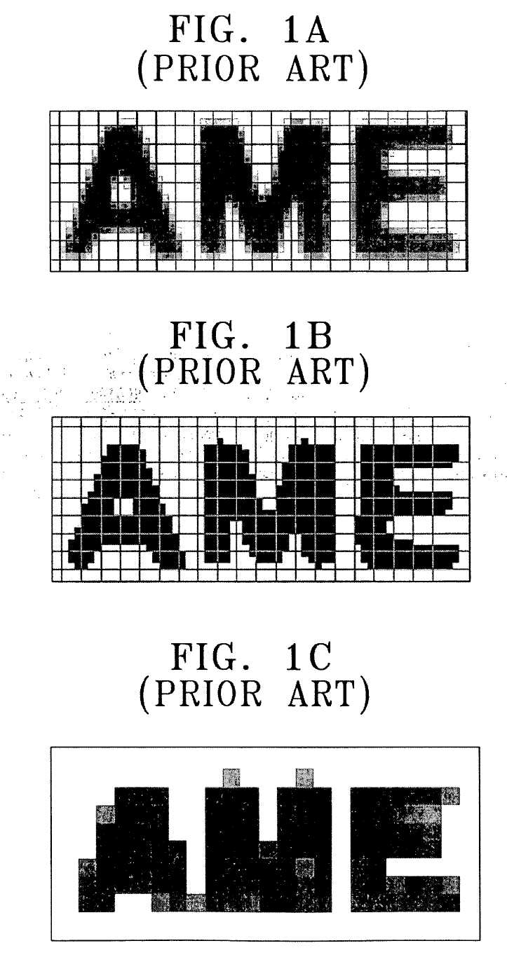

FIG. 2 is a block diagram of a document compression apparatus according to an embodiment of the invention;

FIG. 3 is a block diagram showing the text compressor of FIG. 2 in detail; and

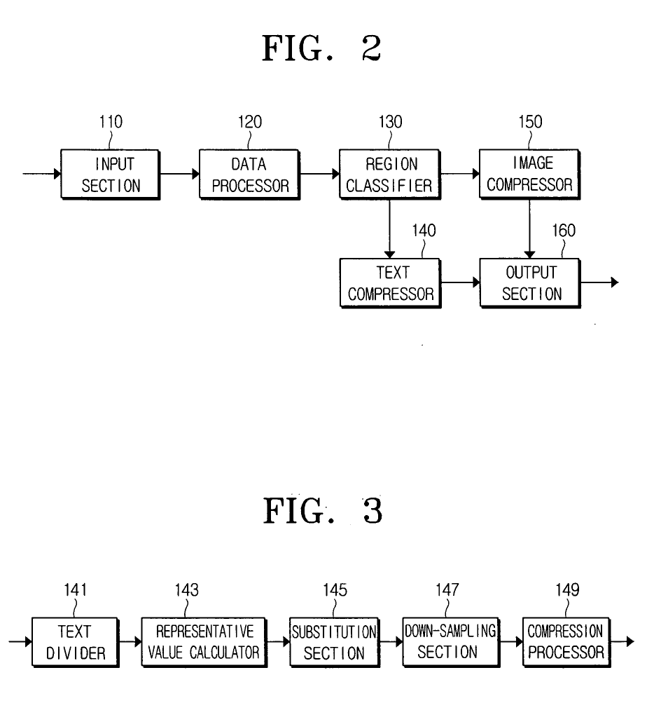

FIG. 4 is a flow chart explaining the operation of the document compression apparatus according to an embodiment of the invention.

Throughout the drawings, like reference numbers should be understood to refer to like elements, features and structures.

### DETAILED DESCRIPTION OF EXEMPLARY EMBODIMENTS

Exemplary embodiments of the present invention will now be described in greater detail with reference to the accompanying drawings.

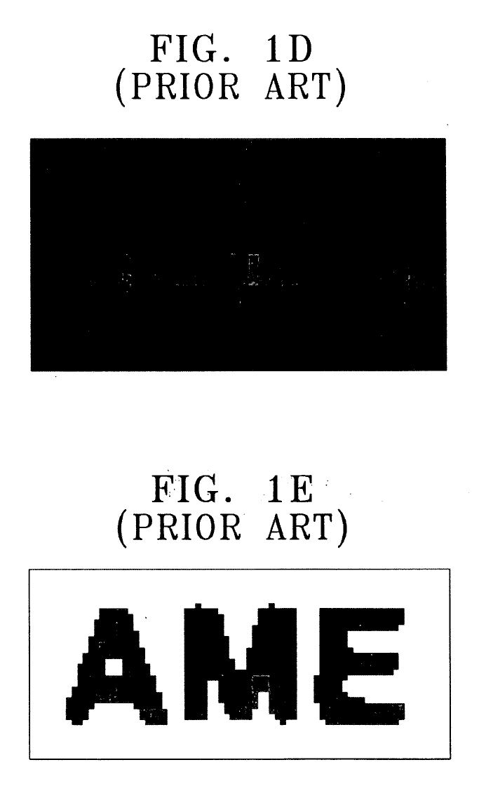

FIG. 2 is a block diagram of a document compression apparatus according to an embodiment of the invention. The document compression apparatus comprises an input section 110, a data processor 120, a region classifier 130, a text compressor 140, an image compressor 150, and an output section 160.

The input section 110 receives image data of a scanned document from an image data generator such as a scanner (not shown) or an information processing device, or an image data storage device.

The data processor 120 performs the required data processing on the image data received through the input section 110.

The region classifier 130 determines a relationship between each pixel and the neighboring pixels using the processed image data and creates a mask layer by separating the text region. Then, using the mask layer data, the region classifier 130 classifies the color data of the text region, and the color data of the image region and the background, and creates upper layer data and lower layer data.

The text compressor 140 compresses the mask layer data classified as a text region and the upper layer data classified as color data corresponding to the mask layer data. For compressing the data, the text compressor 140 includes a text divider 141, a representative value calculator 143, a substitution section 145, a down-sampling section 147, and a compression processor 149.

The text divider 141 divides the region classified as text into at least one continuous pixel group using the mask layer data. The one continuous pixel group represents independent text.

In addition, within the corresponding pixel group, the text divider 141 divides the pixels belonging to any one of the pixel groups into the pixels corresponding to the outside (edge) and the pixels corresponding to the inside of the pixel group region. The classification of the pixels corresponding to the outside and the pixels corresponding to the inside is accomplished by comparing each pixel with the neighboring pixels and applying various well-known methods.

The representative value calculator 143 calculates a representative value for each continuous pixel group extracted by the text divider 141. For example, the representative value calculator 143 calculates the mean of the pixel values of the pixels by assigning a weighting factor. The weighting factor of pixels corresponding to the inside of a pixel group is preferably higher than that of pixels corresponding to the edge. The representative value calculator 143 preferably determines the calculated mean as the representative value.

Using each representative value calculated for each pixel group, the substitution section 145 substitutes the representative value of a pixel group for the pixel value of a pixel belonging to the inside of a pixel group.

In order to prevent misclassifying an image region as a text region and performing substitution with a representative value and compression by mistake, the amount of difference between one group of text pixels and the next is calculated when classifying a text or extracting pixel groups of a different text. The pixel values of neighboring pixels that are not an edge (that is, pixels that belong to the inside of a pixel group) are compared, and in the case where the amount of change from one inside group to the next exceeds a predetermined threshold value, it is preferable not to calculate a representative value and not to perform a substitution process with a representative value.

The down-sampling section 147 down-samples the upper layer data in a lowered resolution and transmits it to the compression processor 149. The pixel value of the upper layer data is substituted by the substitution section 145.

The compression processor 149 compresses the down-sampled upper layer data using an appropriate method selected from among well-known compression methods such as JPEG. In addition, the compression processor 149 compresses the bit map data classified as a mask layer using an appropriate method selected from among well-known compression methods such as JBIG.

On the other hand, the image compressor 150 compresses the lower layer data classified as an image data by applying a compression method appropriate for the characteristics of an image data selected from among well-known compression methods.

The output section 160 outputs the compressed image data.

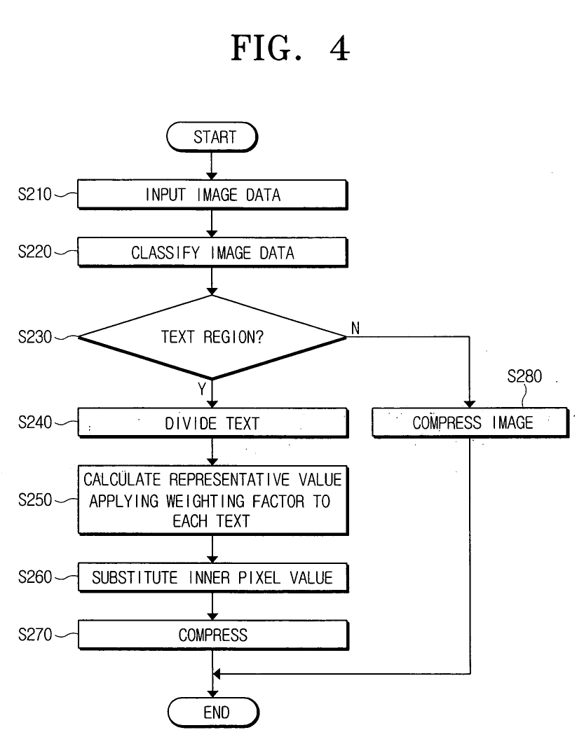

FIG. 4 is a flow chart explaining the operation of the document compression method according to an embodiment of the invention.

If the image data of a scanned document is received at step S210, the received image data generally being received in the form of R, G, B constituents of the original image, the data processor 120 calculates the received R, G, B constituents to obtain the image data, that is, a pixel value, represented in the constituents of hue, luminance, and saturation, and thus a pixel map is created.

The region classifier 130 classifies each pixel into text, image, and background regions using the pixel value of each pixel in a pixel map, preferably using a brightness data at step S220. Then, the region classifier 130 creates a mask layer that identifies whether the pixel is in the text region or in the other regions, separates the upper layer from the pixel map using the mask layer, the upper layer formed of the color data of the pixels corresponding to the text, and separates the lower layer formed of the color data of the pixels corresponding to the image other than that of the text. In addition, the region classifier 130 classifies the text into an inner text region and an outer text region at step S220. A plurality of well-known methods can be used for the region classification.

Then, at step S230 it is determined whether a particular pixel belongs to a text region. Depending on whether the pixel belongs to a text region or not, compression is performed by applying a different compression algorithm respectively. For the pixels classified as an image region, data is compressed at step S280 by applying an appropriate compression algorithm according to the characteristic of the image data.

On the other hand, in the case of the text region, the region classified as text is divided into at least one continuous pixel group using the mask layer data, and an independent text group is extracted at step S240. That is, the pixels classified as a text group can have different colors according to each text group, so that the pixels classified as a text region are divided into a predetermined number of groups. Such grouping advantageously prevents degradation of image quality as described above, wherein text having a certain color comes to have various colors in a series of data processing procedures such as down-sampling, compressing, and restoring. A method according to an embodiment of the present invention considers the continuous pixels belonging to text as a group, a representative pixel value is calculated for each group at step S250 and one representative pixel value is substituted for all the pixels belonging to one group at step S260. Thus each text group is represented with one color.

Then, the pixels belonging to any one of the pixel groups are divided within the pixel group into the pixels corresponding to the edge and the pixels corresponding to the inside of the region of the pixel group. The classification of the pixels corresponding to the edge and the pixels corresponding to the inside is accomplished by comparing each pixel and their neighboring pixels and applying various well-known methods.

The process of calculating a representative value will now be described in greater detail. A representative value is calculated at step S250 for each continuous group. For example, the representative value calculator 143 calculates a representative value by assigning different weighting factors to the pixels corresponding to the inside of the text and to the pixels corresponding to the outside of the text and calculating the mean of the pixel values. For text, the weighting factor of the pixels corresponding to the inside of the text is preferably higher than the weighting factor of the pixels corresponding to the outside of the text.

Then, using each representative value calculated for each pixel group, the pixel value of the pixel belonging to the inside of the pixel group is substituted with the representative value at S260.

Finally, the upper layer data, the pixel values of which are substituted, is down-sampled in a lowered resolution, and each of the bit map data classified as a mask layer and the down-sampled upper layer data is compressed at step S270 by an appropriate method selected from among several well-known compression methods respectively. Here, the characteristics of the mask layer and the upper layer are different from each other. The mask layer is bit map data representing the text and the upper layer represents the color data corresponding to the text, so that applying a different compression algorithm to each layer respectively is preferable.

According to an embodiment of the invention, when compressing a mixed document of texts and images, the pixels belonging to the text region and the images in a screen to be compressed are respectively classified into groups of continuous text, substituted with a predetermined representative value and compressed, while maintaining the original constant color of the text, thereby preventing degradation of image quality. Therefore, in the case where a region has a constant color and the color information of a region is of low importance, the influence of scanning, down-sampling, compressing, and restoring is minimized, and the color of the text in an image can be prevented from being changed to various colors during restoration.

The foregoing embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the invention, which is defined by the following claims. Many alternatives, modifications, and variations will be apparent to those skilled in the art, and such alternative, modifications and variations should be considered within the scope of the invention.

What is claimed is:

1. A document compression apparatus comprising:
an input section for receiving image data created by scanning a document;
a region classifier for analyzing the image data and classifying it into a text region and an image region;
a text compressor for substituting a predetermined representative value for a pixel value of a pixel belonging to the text region and compressing an image data of the text region; and
an image compressor for compressing an image data of the image region.

2. The apparatus as claimed in claim 1, wherein the text compressor includes:
a text divider for detecting interconnectivity according to locations of the pixels belonging to the text region and dividing the pixels into pixel groups having consecutively connected pixels;
a representative value calculator for calculating a representative pixel value for each pixel group; and
a substitution section for substituting the representative pixel value for the pixel value of each pixel included in the pixel group respectively.

3. The apparatus as claimed in claim 2, wherein the text divider divides the pixels belonging to each pixel group into the pixels within the pixel group and the pixels outside of the pixel group respectively, and the representative value calculator calculates the representative pixel value by assigning different weighting factors to the pixels within the pixel group and the pixels outside of the pixel group respectively.

4. The apparatus as claimed in claim 2, wherein the representative value calculator assigns a weighting factor to the pixel value of pixels within the pixel group, the weighting factor being higher than that of the pixel value of pixels outside of the pixel group, and calculates a mean value of the weighted pixel values as the representative value.

5. The apparatus as claimed in claim 2, wherein the substitution section compares pixel values of pixels belonging to a pixel group, and, in cases where the difference exceeds a predetermined threshold value, the representative value is not substituted for the pixel value.

6. The apparatus as claimed in claim 1, wherein the region classifier separates a black and white bit map data representing the text region from the image data, and classifies the image data into a color data representing the text region and the image data representing the image region using the black and white bit map data.

7. The apparatus as claimed in claim 6, wherein the text compressor calculates the representative value of the pixels belonging to the text region using the color data.

8. The apparatus as claimed in claim 6, wherein the text compressor applies a different compression method to the bit map data, the color data, and the image region respectively according to characteristics of the data, wherein the image data is classified into the bit map data, the color data, and the image region.

9. A document compression method comprising steps of:
receiving image data;
analyzing the image data and classifying it into a text region and an image region;
calculating a representative pixel value for at least one pixel group after dividing the text region into at least one pixel group having consecutively connected pixels respectively;
substituting the representative pixel value for a pixel value of each pixel included in at least one pixel group; and
compressing image data of the text region and image data of the image region.

10. The method as claimed in claim 9, wherein the representative pixel value calculating step divides the pixels belonging to the pixel groups into pixels within the pixel group and pixels outside of the pixel group respectively, and calculates the representative pixel value by assigning different weighting factors.

11. The method as claimed in claim 10, wherein the representative pixel value calculating step assigns a weighting factor to a pixel value of a pixel within a pixel group, the weighting factor being higher than that of a pixel value of a pixel outside of a pixel group, and calculates a mean value of weighted pixel values as the representative value.

12. The method as claimed in claim 9, wherein the substituting step compares pixel values of pixels belonging to different pixel groups, and, in the case where the difference exceeds a predetermined threshold value, the representative value is not substituted for the pixel value.

13. The method as claimed in claim 9, wherein the region classifying step separates black and white bit map data representing the text region from the image data, and classifies the image data into color data representing the text region and image data representing the image region using the black and white bit map data.

14. The method as claimed in claim 13, wherein the representative pixel value calculating step calculates the representative pixel value of the pixels belonging to the text region using the color data.

15. The method as claimed in claim 13, wherein the compressing step applies different compression methods to the bit map data, the color data, and the image region respectively according to characteristics of the data, wherein the image data is classified into the bit map data, the color data, and the image region.

16. A computer readable medium of instructions for controlling a document compression apparatus comprising:
a first set of instructions adapted to control the apparatus to receive image data;
a second set of instructions adapted to control the apparatus to analyze the image data and classify it into a text region and an image region;
a third set of instructions adapted to control the apparatus to calculate a representative pixel value for at least one pixel group after dividing the text region into at least one pixel group having consecutively connected pixels respectively;
a fourth set of instructions adapted to control the apparatus to substitute the representative pixel value for a pixel value of each pixel included in at least one pixel group; and
a fifth set of instructions adapted to control the apparatus to compress image data of the text region and image data of the image region.

17. The computer readable medium of claim 16, wherein the third set of instructions is further adapted to control the apparatus to divide the pixels belonging to the pixel groups into pixels within the pixel group and pixels outside of the pixel group, respectively, and to calculate the representative pixel value by assigning different weighting factors.

18. The computer readable medium of claim 17, wherein the third set of instructions is further adapted to control the apparatus to assign a weighting factor to a pixel value of a pixel within a pixel group that is higher than that of a pixel value of a pixel outside of the pixel group, and to calculate a mean value of the weighted pixel values as the representative value.

19. The computer readable medium of claim 16, wherein the fourth set of instructions is further adapted to control the apparatus to compare pixel values of pixels belonging to different pixel groups, and, in the case where the difference exceeds a predetermined threshold value, the representative value is not substituted for the pixel value.

20. The computer readable medium of claim 16, wherein the second set of instructions is further adapted to control the apparatus to separate black and white bit map data representing the text region from the image data, and classify the image data into color data representing the text region and image data representing the image region using the black and white bit map data.
